(19) United States
(12) Patent Application Publication
(10) Pub. No.: US 2011/0050001 A1
(43) Pub. Date: Mar. 3, 2011

(54) Method and System for Providing an On/Off Switch for an Electrical Charger Transformer at the Low Voltage Device Connector

(76) Inventor: Perrin Dake, Boulder, CO (US)

(21) Appl. No.: 12/553,011

(22) Filed: Sep. 2, 2009

(51) Int. Cl. H01H 9/54

(52) U.S. Cl. 307/139

(57) ABSTRACT

A method and system for providing an on/off switch for an electrical charger transformer at the low voltage device connector are provided. The electrical charger transformer of the present invention enables the conservation of energy. The electrical charger transformer includes an on/off switch that is located at the end of the electrical charger transformer at the low voltage device connector that connects the electrical charger transformer to a load. The on/off switch of the electrical charger transformer is ergonomically designed and configured to manually turn on and off based on the motion of the user hand when connecting and disconnecting the low voltage device connector from the load of the electrical charger transformer.

### BACKGROUND OF THE INVENTION

1. Field of the Invention

The present invention relates to a method and system for an electrical charger transformer. More particularly, the present invention relates a method and system for providing an on/off switch for an electrical charger transformer at the low voltage device connector of the electronic charger transformer.

2. Description of the Prior Art

An electrical charger transformer (hereinafter “power supply”) is typically used to connect a load to a commercial power supply to provide the load with electrical energy or charge a battery associated with the load. A load can include, but is not limited to, electrical devices, such as a PDAs, portable computers, music devices, DVD players and mobile telephones. When a load is not connected to the power supply, the magnetic field of the power supply's transformer will continuously consume electrical power (standby power) from the commercial power supply unless the power supply is unplugged from the commercial power supply.

Standby power, also called vampire power, vampire draw, phantom load, or leaking electricity, refers to the electric power consumed by electronic appliances while they are switched ‘off’ or in a standby mode. A very common “electricity vampire” is a power adapter which has no power-off switch. Some such devices offer remote controls and digital clock features to the user, while other devices, such as power adapters for laptop computers and other electronic devices, consume power without offering any features.

With energy conservation becoming a major global concern, society is looking for ways to conserve energy at all levels. Conserving the energy consumed by power supplies is one area in which energy can be conserved. The typical technique to conserve the energy consumed by a power supply has been to plug the power supply into a power strip that can be completely turned off, thus eliminating any phantom load through the use of an on/off switch on the power strip. However, this technique suffers from the drawback that when the power strip is turned off no other device that is plugged into the power strip can receive any electricity even though the use of the other devices may be desired.

Other techniques include providing an on/off switch at the location of the power supply's transformer or at the end of a separate cable that is different than the cable that attaches the power supply to the load. This technique suffers from the drawback that a user of the power supply must consciously remember to access or locate the switch and perform a specific action to turn the on/off switch on and off.

There is a need for an electrical charger transformer that conserver energy. There is a need for the electrical charger transformer to include an on/off switch. There is a need for the on/off switch to be located at the end of the electrical charger transformer at the low voltage device connector that connects the electrical charger transformer to a load. There is a need for the on/off switch of the electrical charger transformer to be ergonomically designed. There is a need for the on/off switch to manually turn on or off based on the motion of the user hand when connecting and disconnecting the load from the electrical charger transformer.

### SUMMARY OF THE INVENTION

A brief summary of the present invention is given as follows to provide a basic understanding of certain aspects of the present invention. But it shall be comprehended that this summary is not an exhaustive summary of the present invention. It does not intend to define the key part of important part of the present invention, or limit the scope of the present invention. The purpose is only to give some concepts about the present invention in a simplified form, as a preface of the subsequent detailed descriptions. For a person skilled in the art, the following aspects of the present invention and the technical solution defined by the accompanied independent claims can be in any possible appropriate combinations with the examples in the present invention and/or the dependent claims.

A first aspect of the present invention provides an electrical charger transformer capable of eliminating phantom loads The electrical charger transformer includes an outlet connector operable to plug into a commercial power supply, a transformer having an input side and an output side. A first input on the input side receives a first type of input from the outlet connector and a second input on the input side receives a second type of input from an on/off switch. A switch adapter casing including a device connector and the on/off switch is also included provided. The device connector is configured to receive a DC voltage from the output side of the transformer and provide the DC voltage to a device. The on/off switch is configured to receive the second type of input from the outlet connector and provide the second type of input to the second input when the on/off switch is in an on state and block the second type of input to the second input when the on/off switch is in an off state.

In the electrical charger transformer of the first aspect of the present invention, the first type of input is a positive input and the second type of input is a neutral input.

In the electrical charger transformer of the first aspect of the present invention, the first type of input is a neutral input and the second type of input is a positive input.

In the electrical charger transformer of a second aspect of the present invention, a high voltage pair cable for coupling the outlet connector to the transformer and providing the first type input and the second type input is provided.

In the electrical charger transformer of the second aspect of the present invention, the on/off switch is ergonomically designed for a thumb and forefinger.

In the electrical charger transformer of the second aspect of the present invention, the on/off switch enters an on state in response to plugging the device connector into a device.

In the electrical charger transformer of a third aspect of the present invention, an LED that turns on when the on/off switch is in the on state.

In the electrical charger transformer of the third aspect of the present invention, the on/off switch enter an off state in response to unplugging the device connector from a device.

### BRIEF DESCRIPTION OF THE DRAWINGS

The above described features and advantages of the present invention will be more fully appreciated with reference to the detailed description and appended figures in which:

FIG. 1 depicts an exemplary diagram of an electrical charger transformer with an on/off switch according to an embodiment of the present invention;

FIG. 2A depicts an exemplary diagram of an electrical charger transformer with a retractable on/off switch in an extended position according to an embodiment of the present invention;

FIG. 2B depicts an exemplary diagram of an electrical charger transformer with a retractable on/off switch in a retracted position according to an embodiment of the present invention;

FIG. 3 depicts an exemplary diagram of an electrical charger transformer according to an embodiment of the present invention;

FIGS. 4A-4B depict exemplary diagrams of device connectors according to embodiments of the present invention; and

FIGS. 5A-5B depict exemplary on/off switches according to an embodiment of the present invention.

The present invention is now described more fully hereinafter with reference to the accompanying drawings that show embodiments of the present invention. The present invention, however, may be embodied in many different forms and should not be construed as limited to embodiments set forth herein. Appropriately, these embodiments are provided so that this disclosure will be thorough and complete, and will fully convey the scope of the present invention.

According to an embodiment of the present invention, a method and system for providing an on/off switch for an electrical charger transformer at the low voltage device connector are provided. The electrical charger transformer of the present invention enables the conservation of energy. The electrical charger transformer includes an on/off switch that is located at the end of the electrical charger transformer at the low voltage device connector that connects the electrical charger transformer to a load. The on/off switch of the electrical charger transformer is ergonomically designed and configured to turn on and off based on the motion of the user hand when connecting and disconnecting the low voltage device connector from the load of the electrical charger transformer.

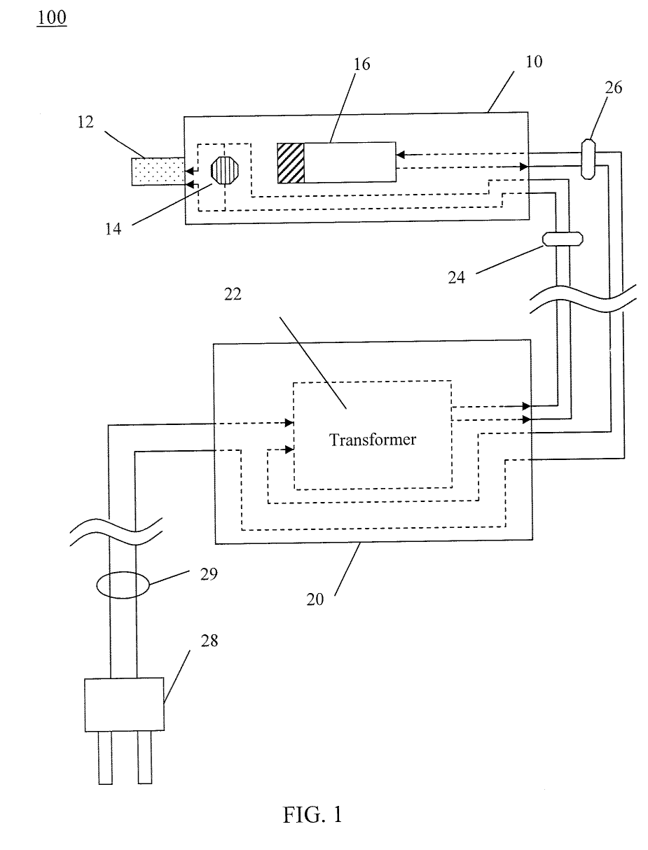

An Exemplary diagram of an electrical charger transformer 100 with an on/off switch according to an embodiment of the present invention is shown in FIG. 1. In the embodiment of FIG. 1, an electrical charger transformer includes a switch adapter casing 10, a device connector 12, on/off switch 16 (shown in the on position), low voltage pair cable 24, high voltage single switched side cable 26, transformer 22, transformer casing 20, high voltage pair cable 29 and outlet connector 28. In an embodiment of the present invention, the switch adapter casing 10 includes an LED that remains in lit state when the on/off switch 16 is in the ‘on’ position. The LED light goes out when the on/off switch 16 is in the ‘off’ position. In the FIG. 1 embodiment of the present invention, the device connect 12 is configured in a fixed extended position from the switch adapter casing 10.

In the FIG. 1 embodiment of the present invention, a first end of the high voltage pair cable 29 couples to the outlet connector 28 that is configured to plug into a commercial power supply to receive an AC voltage. In an embodiment of the present invention, the length of the high voltage pair cable is variable but can typically be in the range of 1-3 feet. A high voltage single transformer side cable of the second end of the high voltage pair cable 29 enters the transformer casing 20 and couples to the transformer 22 on a first side. The high voltage single transformer side cable of the second end of the high voltage pair cable 29 is configured to supply an amount of volts AC (“Hot” or “positive”) as input to a first input of transformer 22. In an embodiment of the present invention, the amount of volts AC supplied as input is typically between 100-240V AC. In an embodiment of the present invention, the amount of volts AC receivable as input is modifiable to accommodate the casing 20, enters the switch adapter casing 10, couples to on/off switch 16, returns to transformer 22 and couples to a second input of transformer 22. The high voltage single switch side cable 26 of the second end of the high voltage pair cable 29 is configured to supply near zero volts (“neutral”) as input to the second input of transformer 22 and complete a circuit to supply the 120-240 volts AC to transformer 22. In an embodiment of the present invention, the first input of the transformer 22 is for the neutral input and the second input of the transformer 22 is for the positive input. One having ordinary skill in the art would recognize how to implement the present invention according to such an embodiment. A first end of the low voltage pair cable 24 couples to an output of the transformer 22 and a second end of the low voltage pair cable 24 couples to the device connector 12. The low voltage pair cable 24 is configured to supply DC voltage from an output side of the transformer 22 to device connector 12.

In an embodiment of the present invention, during operation of the electrical charger transformer 100, a user plugs the outlet connector 28 into a commercial power source to supply AC voltage through high voltage pair cable 29 to transformer 22. Within transformer casing 20, the high voltage single transformer side cable supplies an AC voltage to a first input of the transformer 22. In response to a user inserting the device connector 12 into a load (i.e., device or appliance), the on/off switch 16 is placed into the ‘on’ position (on state) due to the user's hand motion when inserting the device connector 12 into the device. Once the on/off switch 16 is in the on position, the electrical circuit to the input side of transform 22 is complete allowing DC voltage to be generated DC voltage at the output side of the transformer 22, which is supplied by low voltage pair cable 24 to device connector 12 for use by a device.

Likewise, in response to a user unplugging the device connector 12 from a device, the on/off switch 16 is placed into the ‘off’ position (off state) due to the user's hand motion when unplugging the device connector 12 from the device. Once the on/off switch 16 is in the ‘off’ position, the electrical circuit to the input side of the transformer 22 is opened. In this state, there is no energy being consumed by the transformer 22 because the circuit at the input side of the transformer 22 is not completed. In an embodiment of the present invention, the switch adapter casing 10 is ergonomically designed so that a user's thumb and forefinger fit naturally around the switch adapter casing 10. Thus with the electrical charger transformer in the ‘off’ position, no power is being drawn by transformer 22 and any phantom load is eliminated.

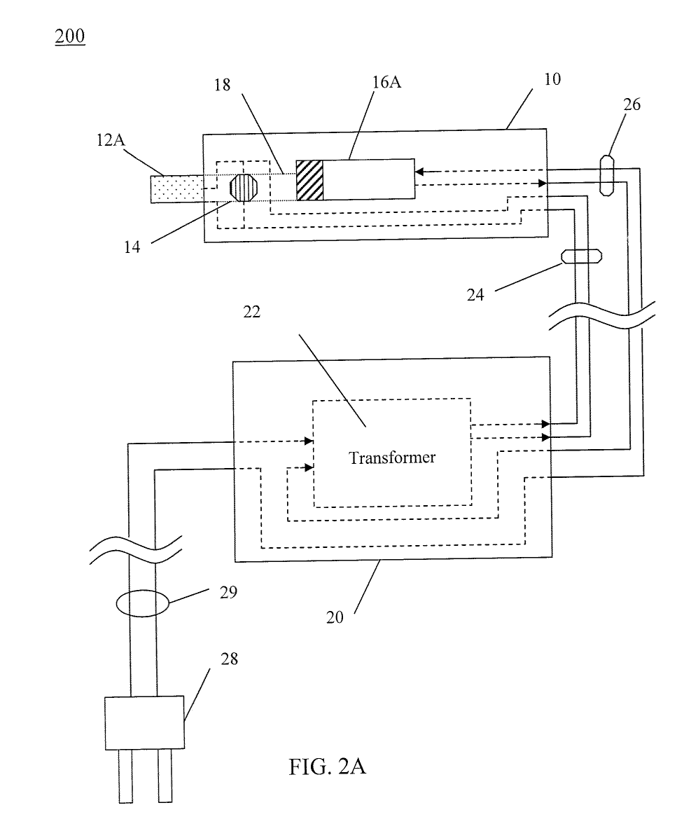

FIGS. 2A-2B depict exemplary diagrams of an electrical charger transformer with a retractable on/off switch according to an embodiment of the present invention. In the FIG. 2A embodiment of the present invention, the on/off switch 16A includes a retractable device connector 12A and a cavity 18. In the ‘on’ position, the retractable device connector 12A is pushed by on/off switch 16A through cavity 18 and out of an opening in switch adapter casing 10 so that retractable device connector 12A extends outside of the switch adapter casing 10. In the FIG. 2B embodiment of the present invention, the retractable device connector 12A is retracted into cavity 18 by on/off switch 16A so that it is recessed within switch adapter casing 10 and is in the ‘off’ position.

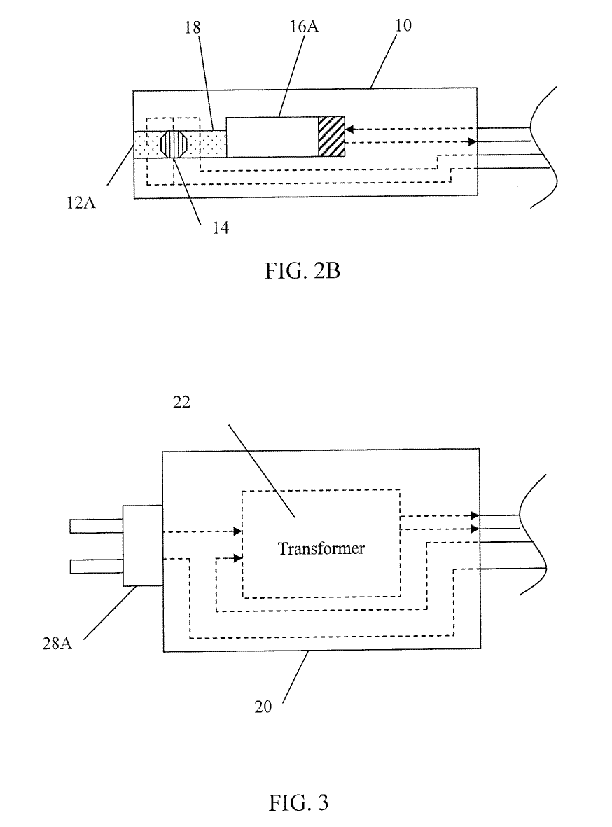

FIG. 3 depicts an exemplary diagram of an electrical charger transformer. In the FIG. 3 embodiment of the present invention, an outlet connector 28A is directly attached to transformer casing 20.

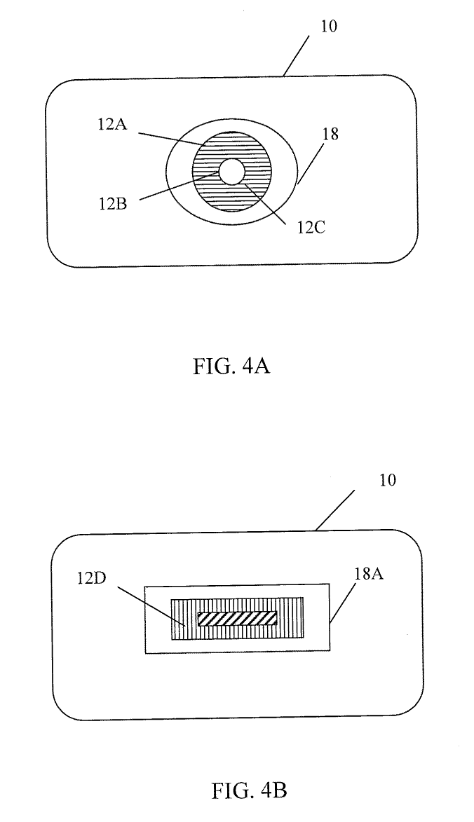

FIGS. 4A-4B depict exemplary diagrams of device connectors according to embodiments of the present invention. In the FIG. 4A embodiment of the present invention, a frontal view of a cylindrical connector 12 is illustrated within a cavity 18 of a switch adapter casing 10. As shown, the cylindrical connector 12 includes a device connector outer edge 12A and a device connector inner edge 12B with connector insulation 12C between the device connector outer edge 12A and the device connector inner edge 12B. In an embodiment of the present invention, the device connector outer edge is DC negative and the device connector inner edge 12B is DC positive. In an alternative embodiment of the present invention, the device connector outer edge is DC positive and the device connector inner edge 12B is DC negative.

In the FIG. 4B embodiment of the present invention, a frontal view of a rectangular connector 12D is illustrated within a cavity 18A of a switch adapter casing 10. While the device connectors 12 discussed have been limited to cylindrical and rectangular type device connectors, one having ordinary skill in the art would recognize that additional types of device connectors include, but are not limited to, snap and lock, Molex, mini IEC, Tamiya, Deans, JST RCY, locking Molex, inverter tabs—inverter lugs, airline in-seat power supply system, Anderson Powerpole, SAE, cigar lighter socket and plugs DIN 4165 and XLR and the like. The connectors shown are by way of example and not of limitation.

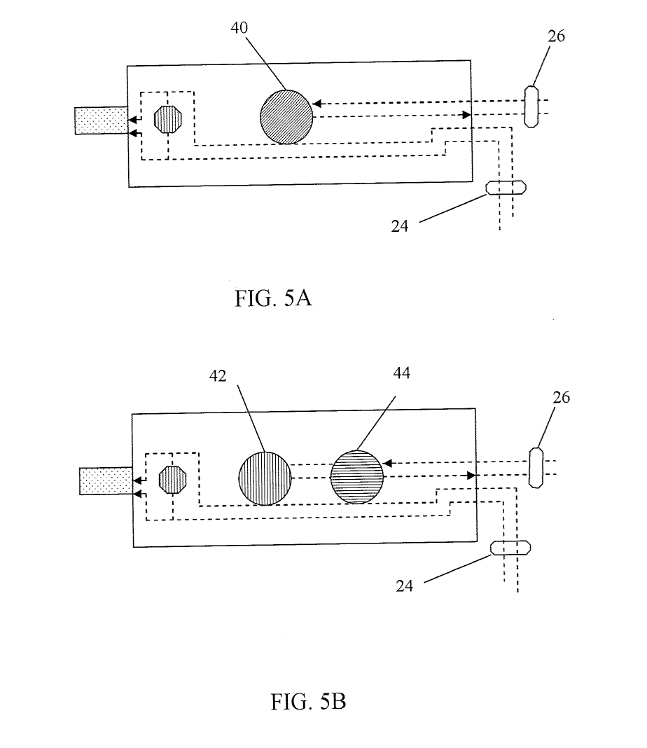

FIGS. 5A-5B depict exemplary on/off switches according to an embodiment of the present invention are shown by way of example and not of limitation. In the FIG. 5A embodiment of the present invention, a single position on/off switch 40 is shown. The single position on/off switch 40 toggles between an ‘off’ state and an ‘on’ state in response to being pressed by a finger of a user. In the FIG. 5B embodiment of the present invention, a double position ‘on’ switch 42 and a double position ‘off’ switch 44 are shown. The double position ‘on’ switch 42 enters an ‘on’ state in response to being pressed by a finger of a user. Likewise, the double position ‘off’ switch 44 enters an ‘off’ state in response to being pressed by a finger of a user.

While specific embodiments of the present invention have been illustrated and described, it will be understood by those having ordinary skill in the art that changes can be made to those embodiments without departing from the spirit and scope of the invention.

What is claimed is:

1. An electrical charger transformer comprising
an outlet connector operable to plug into a commercial power supply;
a transformer having an input side and an output side, wherein a first input on the input side receives a first type of input from the outlet connector and a second input on the input side receives a second type of input from an on/off switch;
a switch adapter casing including a device connector and the on/off switch, wherein the device connector is configured to receive a DC voltage from the output side of the transformer and provide the DC voltage to a device; and
the on/off switch is configured to receive the second type of input from the outlet connector and provide the second type of input to the second input when the on/off switch is in an ‘on’ state and block the second type of input to the second input when the on/off switch is in an ‘off’ state.

2. The electrical charger transformer of claim 1, wherein the first type of input is a positive input and the second type of input is a neutral input.

3. The electrical charger transformer of claim 1, wherein the first type of input is a neutral input and the second type of input is a positive input.

4. The electrical charger transformer of claim 1, further comprising a high voltage pair cable for coupling the outlet connector to the transformer and providing the first type input and the second type input.

5. The electrical charger transformer of claim 1, wherein the on/off switch is ergonomically designed for a thumb and forefinger.

6. The electrical charger transformer of claim 1, wherein the on/off switch enter an ‘on’ state in response to plugging the device connector into a device.

7. The electrical charger transformer of claim 6, further comprising an LED that turns ‘on’ when the on/off switch is in the ‘on’ state.

8. The electrical charger transformer of claim 1, wherein the on/off switch enter an off state in response to unplugging the device connector from a device.

9. The electrical charger transformer of claim 1, wherein a phantom load is eliminated when the on/off switch is in an ‘off’ state.
